(19) United States
(12) Patent Application Publication
(10) Pub. No.: US 2023/0073557 A1
(43) Pub. Date: Mar. 9, 2023

(54) Grid-Energy Firming Process

(71) Applicant: Origen Power Ltd, West Midlands (GB)

(72) Inventor: Tim Kruger, West Midlands (GB)

(21) Appl. No.: 17/799,317

(22) PCT Filed: Feb. 11, 2021
(86) PCT No.: PCT/GB2021/050313

§ 371 Date: Aug. 12, 2022

(30) Foreign Application Priority Data
Feb. 13, 2020 (GB) 2001961.8

(51) Int. Cl. C10J 3/02

(52) U.S. Cl. CPC C10J 3/02; C10J 2300/1671; C10J 2300/1693; C10J 2300/093; C10J 2300/0943; C10J 2300/0916; C10J 2300/0956

(57) ABSTRACT

A grid-energy firming process and a grid energy firming system. The process comprises alternating between a process for generating electrical energy, and a process for generating gaseous fuels in response to the energy demands of a grid energy system. The system comprises a reactor containing a carbonaceous fuel, and a heat exchanger to extract heat from the flue gas and/or gaseous fuel.

The invention relates to a grid energy firming process, in particular to a process comprising alternating between a process for generating electrical energy, and a process for generating storable gaseous fuels, in response to the energy demands of a grid energy system. A grid energy firming system and use of the process or system in grid energy firming or storage are also disclosed.

Grid energy firming and storage is essential to the constant provision of electricity to any large-scale electrical power grid. In order for the grid to supply power at constant voltage, supply of energy into the grid and demand for energy from the grid must be closely matched at all times. Demand for energy from the grid varies according to daily and seasonal cycles and while it can be predicted to a large degree, it cannot be predicted with complete certainty. Supply of energy into the grid results from the sum of supplied energy from the power suppliers attached to the grid. Some of these power sources can be considered constant (e.g. nuclear or to a lesser extent coal-fired power). Other sources can be turned on and off more rapidly (e.g. gas-fired power) or even instantly (e.g. pump storage). Other sources such as wind, solar, wave and tidal (which all happen to be renewable sources) are variable. While to a large extent tidal provides a predictable flow of power, the other renewable sources vary in the amount of power that they supply at any given time depending on the weather conditions.

The requirement to match supply and demand results in a need to store energy when supply exceeds demand, and release energy from those stores when demand exceeds supply. This issue is becoming increasingly prominent as the proportion of energy from renewable sources (which also happen to be intermittent sources) increases. So renewable energy, in attempting to address one problem (climate change) creates another problem (requirement for more energy storage capacity).

The existing paradigm relating to energy storage is to try to store excess energy from renewable sources—that is to make the energy supply from intermittent sources more constant. By storing ‘excess’ renewable energy at times of over-supply and releasing it when there is excess demand, renewable energy (plus storage) can provide a flow of power that better matches demand.

Gravitational pump storage is the conventional form of grid energy storage. At times of excess electricity on the grid, it is used to pump water from a low reservoir to a high reservoir. When demand exceeds supply, the process is reversed, with water being allowed to flow from the high reservoir to the low reservoir driving a turbine and generating the electricity required to balance the grid. This process, while simple, is expensive to run—there are ‘roundtrip’ efficiency losses and the low energy density of storing energy in pumped water necessitates very large volumes to be pumped and associated high capital costs.

Grid energy firming systems therefore effectively provide for a load levelling of power into the grid, such that a constant supply can be provided.

Some chemical storage techniques, such as battery storage, are known. However, these methods are generally costly, and in particular in the case of batteries, prone to poisoning of the system which requires regular maintenance and replacement.

Therefore, there remains a need for a grid energy storage and/or firming system which is reliable, flexible, ideally carbon-neutral or carbon-negative, inexpensive, and can be rapidly implemented.

The invention is intended to overcome or ameliorate at least some aspects of these problems.

Accordingly, in a first aspect of the invention there is provided a grid-energy firming process, the process comprising alternating between a process for generating electrical energy, and a process for generating gaseous fuels in response to the energy demands of a grid energy system. This provides for a system whereby, when there is high demand (and a high unit price) for electricity, the process for generating electrical energy can be employed, yet where there is a lower demand (and a lower unit price), the process for generating gaseous fuels can be employed, converting the chemical energy of the carbonaceous fuel into an alternative chemical form (the gaseous fuel) rather than directly into heat. The gaseous fuel may then be stored, or distributed for use at a time when the energy demand is higher, or for use outside the grid energy system. It will be understood that whilst the invention is primarily for grid energy firming, and so this terminology is used, it could also, in some cases, be applied to grid energy storage.

This flexibility allows the grid-energy firming process to operate continuously, thereby allowing the capital cost of the plant, which operates the process to be spread over more productive hours. As such, this cost is recouped more quickly, and the process is not only more efficient in terms of energy usage (reduced downtime), but also in terms of costs, making the process less expensive than known systems. The continuous operation also enables the system to respond quickly to fluctuating energy supply, as the switching between the two processes is rapid.

Further, the process captures carbon dioxide that is produced before it can enter the atmosphere, thereby avoiding it contributing to climate change. In a world of increasing renewable power generation and increasing demand for hydrogen, the grid-energy firming process claimed allows the production of electricity at times of limited supply by renewables, and provides a system with the ability to produce carbon-neutral or carbon-negative hydrogen or syngas at other times (which can then be stored and drawn upon as required). This creates a highly efficient energy system.

In the grid-energy firming process, the process comprises alternating between a process for generating electrical energy, and a process for generating gaseous fuels in response to the energy demands of a grid energy system. The process for generating electrical energy generally comprises a process for heat generation, wherein the heat generated is converted to electrical energy. The process for heat generation often comprises the reaction of a carbonaceous fuel with oxygen in the presence of lime or other metal oxide to provide calcium, or other metal, carbonate, water and heat. Whilst not explicitly mentioned, other products may also be generated dependent upon, in particular, the nature of the carbonaceous fuel. If necessary, these can be removed using conventional methods, such as catalytic reforming. This heat generation process, which could be considered a co-firing of the carbonaceous fuel with lime, does not produce carbon dioxide, as this reacts in situ with the lime, to produce calcium carbonate, a solid which is easily removed from the system. As such, there is no need for the sorbents commonly present in heat generation systems to be present to remove carbon dioxide. This reduces the parasitic load on the system, as not only is this component not required, reducing capital outlay, but the energy needed to periodically regenerate the sorbent is not required. As a result, this heat generation system is particularly efficient.

It will often be the case in the heat generation process that the carbonaceous fuel reacts with oxygen to produce carbon dioxide, water and heat, and in a subsequent reaction the carbon dioxide recarbonates the lime to produce calcium carbonate and heat. As a result, not only does the heat generation process produce heat from the reaction of the carbonaceous fuel with oxygen (generally combustion in oxygen), but also from the exothermic recarbonation of lime. As such, more energy is produced per unit of carbonaceous fuel than with known methods. Typically for costs and availability reasons, the oxygen will be oxygen from air. Further, the use of air as the source of oxygen simplifies the design of an apparatus for implementation of the grid-energy firming process, as vitiated air is required for use in the process for the generation of gaseous fuels. However, pure oxygen (or gaseous mixtures comprising primarily of oxygen—e.g. in the range 51-100 wt %, often 75-95 wt %) may also be used if, for instance, there is a desire for a nitrogen free flue gas.

As noted above, the recarbonation step also results in the removal of carbon dioxide, preventing its emission. This, if combined with a process that produces a ‘zero-emission lime’ will result in net negative emissions—the overall removal of carbon dioxide from the atmosphere. Typically, the term ‘zero-emission lime’ relates to lime produced by a process in such a way that all (or a substantial proportion) of the carbon dioxide generated by the production of the lime from calcium carbonate (both from the calcination of the calcium carbonate and any emissions associated with the combustion of the fuel required to calcined the calcium carbonate) is not emitted to the atmosphere, but is instead permanently sequestered. Thus the claimed process has the potential to generate heat (and so also potentially electricity) in a way that also removes carbon dioxide from the atmosphere, potentially providing carbon-negative heat generation.

As used herein, the term “lime” is generally intended to refer to calcium oxide, although calcium hydroxide may also be used, calcium oxide as calcium oxide can capture more carbon dioxide than calcium hydroxide. Further, although the application is cast generally in terms of lime and the production of calcium carbonate, it may be the case that other metal oxides, for instance s-block metal oxides such as magnesium oxide, sodium oxide or potassium oxide may be used alone or in combination to produce magnesium, sodium, potassium carbonates or combinations thereof, or combinations with calcium carbonate. Often, where lime is not used, the metal oxide will be an s-block metal oxide, often a group II metal oxide, often magnesium oxide derived from dolomite. As dolomite is often a combination of calcium and magnesium carbonates, the metal oxide may therefore also be a combination of calcium oxide (“lime”) and magnesium oxide (MgO).

The heat generation process generally releases water and heat, referred to here as flue gases. These will generally be hot at the point of exit due to the exothermic natures of the reaction between the carbonaceous fuel and oxygen and the reaction of lime with carbon dioxide to form calcium carbonate. This hot flue gas will typically also comprise nitrogen and oxygen, the nitrogen being from the air that is typically used as the oxygen source, together with any unreacted oxygen. When air is the oxygen source, the flue gas could be considered to comprise water, heat and oxygen depleted air. However, it will generally be the case that the flue gas comprises only nitrogen, oxygen and water. Because of the heat of the flue gas, the water will often be present as steam. Importantly, the flue gas will generally comprise no, or only trace amounts of carbon dioxide, as this will react with the lime before exiting any reactor. Further, the relative mass flows of the carbonaceous fuel, lime and oxygen may be controlled to ensure that only trace, if any, amounts of carbon dioxide escape the system with the flue gases. Therefore, the flue gas may comprise in the range 0-0.001, or in the range 1×10⁻⁵-1×10⁻⁴ volume % carbon dioxide. It will generally be the case that conventional methods will be used to harvest and convert the heat energy into electrical energy, such as the passing of the flue gas through a heat exchanger. The resultant cooled flue gas can then be released to the atmosphere. Optionally, any water vapour remaining (that has not condensed out of the gas during cooling and collected elsewhere), may be removed.

The heat generation process may be described by the following overall reaction:

CₐH_{b}O_{c}+aCaO+x(a+b/2−c)O₂+3.29x(a+b/2−c)N₂→3.29x(a+b/2−c)N₂+(1−x)(a+b/2−c)O₂+bH₂O+aCaCO₃

Which could be simplified to remove the nitrogen (although this would in reality be present if the oxygen source were air) to read:

CₐH_{b}O_{c}+aCaO+x(a+b/2−c)O₂→(1−x)(a+b/2−c)O₂+bH₂O+aCaCO₃

If described as a two-stage process whereby the carbon dioxide is produced and subsequently reacts with the lime, the reaction scheme would appear as:

CₐH_{b}O_{c}+x(a+b/2−c)O₂→(1−x)(a+b/2−c)O₂+bH₂O+aCO₂ a)

CO₂+CaO→CaCO₃ b)

where a, b and c are the molar component of the carbonaceous fuel, and x is the excess air fraction.

As can be seen, the nature of the carbonaceous fuel dictates how much oxygen, water and calcium carbonate are produced and their relative ratios. Using glucose as representative of the carbonaceous fuel, the reaction scheme would appear as follows:

C₆H₁₂O₆+6O₂→6H₂O+6CO₂ a)

6CO₂+6CaO→6CaCO₃ b)

It may be, that in some examples, the temperature of the reaction is controlled to ensure that the two exothermic process, namely the reaction of the carbonaceous fuel in oxygen and the carbonation reaction, do not raise the overall temperature of reaction beyond the calcination temperature of the calcium carbonate. This could reduce the yield of the carbonation reaction. To prevent this, water, or water vapour (for instance low temperature steam), could be added to the reaction, this would function as a heat sink, as it would absorb ambient heat. It will often be the case that at temperatures in the range 700-800° C., the yields of the reaction of the carbonaceous fuel with oxygen and the carbonation reaction are highest, such that it can be advantageous to maintain the reaction temperature in this range.

The grid-energy firming process alternates between the process for generating electrical energy and, as noted above, a process for generating gaseous fuels. The process for the generation gaseous fuels generally comprises gasifying a carbonaceous fuel with vitiated air in the presence of lime and water to provide calcium carbonate, a gaseous fuel and heat. This process, in particular the presence of lime, provides for a system where carbon dioxide is not present in the gaseous fuel. This removes the need to purify the syngas or hydrogen produced, and removes concerns about post-process sequestering of the carbon dioxide by-product. Instead, the carbon dioxide is used to recarbonate the lime (in this case generally calcium oxide rather than calcium hydroxide) into calcium carbonate, a solid which is easily removed from the system. As such, there is no need for the sorbents commonly present to remove carbon dioxide from syngas or hydrogen production systems where carbonaceous fuels are the starting material. Typically, this will be achieved by:

a) gasification of the carbonaceous fuel to produce carbon monoxide and hydrogen;

b) reaction of carbon monoxide with water to produce carbon dioxide and hydrogen; and

c) recarbonation of lime by carbon dioxide to produce calcium carbonate.

Whilst not explicitly mentioned, other products may also be generated dependent upon, in particular, the nature of the carbonaceous fuel. If necessary, these can be removed using conventional methods, such as catalytic reforming.

Without the lime, it would be necessary to add an additional stage to the gaseous fuel production process to remove the carbon dioxide from the gases produced. This would add capital cost to the production facility, and operating costs to the process because of the need to, for instance, regenerate sorbents between uses, and to physically store and transport the carbon dioxide to long term sequestration facilities (for instance underground burial).

If sufficient oxygen is available then when the carbonaceous fuel is combusted in the presence of lime, the carbon dioxide released during the reaction will immediately be captured as the lime reacts with it to form calcium carbonate. This is akin to the reaction process in the heat generation process described above. If, however, there is a lack or absence of oxygen, such as when air is vitiated, then there will either be incomplete combustion (in the event of there being a lack of oxygen) or no combustion (if there is no oxygen). In such circumstances the amount of heat generated will be less, but instead there will be production of a syngas (as used herein, a mixture of carbon monoxide and hydrogen, as carbon dioxide has been captured) or hydrogen as the carbonaceous fuel gasifies. As such, by controlling the oxygen levels present under reaction conditions, the heat generation process (and so the generation of electrical energy) can be quickly and easily switched to the process for generating gaseous fuel. This rapid alternation between the two processes, provides for a grid-energy firming process which can rapidly respond to the energy needs of the grid energy system.

The gaseous fuel generation process may be described by the following overall reaction:

CₐH_{b}O_{c}+aCaO+N₂+H₂O→N₂+CₓH_{y}+(a−x)CaCO₃

Which could be simplified to remove the nitrogen from the equation (although this would remain present in the vitiated air) to read:

CₐH_{b}O_{c}+aCaO+H₂O→CₓH_{y}+(a−x)CaCO₃

where a, b and c are the molar component of the carbonaceous fuel, x may vary from 0 to 8 and y may vary from 2 to 14.

An example of the generation of gaseous fuels is shown below, using glucose as representative of the carbonaceous fuel.

a) gasification of the carbonaceous fuel to produce carbon monoxide and hydrogen:

C₆H₁₂O₆→6CO+6H₂;

b) reaction of carbon monoxide with water to produce carbon dioxide and hydrogen:

6CO+6H₂O→6CO₂+6H₂; and

c) recarbonation of lime by carbon dioxide to produce calcium carbonate:

6CaO+6CO₂→6CaCO₃.

The relative mass flows of the carbonaceous fuel, lime and vitiated air may be controlled to ensure that only trace, if any, amounts of carbon dioxide escape the system with the flue gases. Therefore, the flue gas may comprise in the range 0-0.001, or in the range 1×10⁻⁵-1×10⁻⁴ volume % carbon dioxide.

Normal gaseous fuel production processes (for instance syngas or hydrogen production) require a proportion of the carbonaceous fuel to be combusted to provide sufficient heat to drive the endothermic gasification process. However, with the addition of the recarbonation step, the overall reaction is heat-generating, and so a proportion of the carbonaceous fuel does not need to be combusted to provide heat energy—all of the carbonaceous fuel can be gasified. This provides for a more efficient process than has been known, as all of the carbonaceous fuel, can be converted to gaseous fuel, without loss of energy potential in driving the conversion reaction. It is desirable to generate gaseous fuels from carbonaceous fuels as these are generally cleaner (in that there are fewer unwanted products mixed with the fuel), easier to purify when necessary, and higher in per unit energy. This is particularly the case where the carbonaceous fuel is a solid fuel such as coal or biomass (any organic matter that is used as a fuel).

In addition, the overall reaction (e.g. C₆H₁₂O₆+6H₂O+6CaO→6CaCO₃+12H₂) requires water on the left hand side, this appearing in the water-gas shift reaction. Thus it is not necessary to completely dry the carbonaceous fuel prior to use in the process. This removes a cost and energy-intensive step usually associated with hydrogen or syngas production, in particular where the carbonaceous starting material is biomass.

As noted above, the recarbonation step also results in the removal of carbon dioxide, preventing its emission. This, if combined with a process that produces a ‘zero-emission lime’ can result in net negative emissions—the overall removal of carbon dioxide from the atmosphere. Thus the process has the potential to generate hydrogen or syngas in a way that also removes carbon dioxide from the atmosphere, potentially providing carbon-negative gaseous fuel generation.

As used herein, the term “fuel” may be used to describe any material which can be burned to generate power. The carbonaceous fuel for use in the heat generation process may be gaseous, liquid or solid; although often it will be solid for ease of handling. However, as this is not essential, the carbonaceous material for use in the heat generation process may be selected from coal, coke, lignite, syngas, biomass (any organic matter that is used as a fuel), biogas (any gaseous fuel derived from the fermentation of organic matter), one or more hydrocarbons (solid, liquid or gaseous at room temperature), or a combination thereof. Where the carbonaceous fuel is a solid, it may be selected from coal, coke, lignite, biomass, one or more solid hydrocarbons, or a combination thereof. Often the carbonaceous fuel for either process will be from a renewable source, such as biomass (for instance algal or cellulosic), or biogas if gaseous.

Furthermore, where the carbonaceous fuel is biomass, the biomass production itself will have removed carbon dioxide from the air via the photosynthetic process. In such cases, a typical heat generation process from biomass, assuming it involves the combustion of the carbonaceous fuel in oxygen, is broadly ‘carbon-neutral’ with as much carbon dioxide released as was initially captured during photosynthesis. There remains, however, a small detrimental impact on the climate from biomass combustion, as there will be an associated carbon footprint relating to the production, harvesting and transport of the biomass. However, the carbon footprint of biomass generation can be counteracted if the carbon dioxide from the flue gas is successfully captured and stored away from the atmosphere, as is the case in the processes used in the invention. Further, typical lime production methods, which generally require the release of carbon dioxide from calcium carbonate, will release carbon dioxide into the atmosphere unless positive steps are taken to sequester this. As such, to provide the greatest carbon-negativity in the process, it is desirable that the lime be sourced from suppliers who have considered the problems associated with carbon dioxide release and taken steps to address these.

Thus, one way to provide a carbon-negative process with biomass as the carbonaceous fuel, be this the overall grid-energy firming process, either or both of the two integrated processes of heat (and so electricity) generation and gaseous fuel generation, is to link the following steps, if possible (only the last of which is described in detail in this application):

a) the growing of biomass (resulting in carbon dioxide being removed from the air during photosynthesis);

b) the production of lime without emission of carbon dioxide (for instance, as described in WO 2015/015161 incorporated herein by reference); and

c) the reaction of a carbonaceous fuel with oxygen or vitiated air in the presence of lime.

The net removal of carbon dioxide from the atmosphere is beneficial from a climate perspective, and also financially beneficial if incentivised by such measures as California's Low-Carbon Fuel Standard, which rewards activities that result in the net removal of carbon dioxide from the atmosphere.

The gaseous fuel is often selected from syngas (here, a combination of carbon monoxide and hydrogen as any carbon dioxide will have recarbonated the lime) or hydrogen. These fuels are clean, and, act as excellent feedstocks for the production of longer-chain hydrocarbons and have a high energy density. Often the gaseous fuel will be a low or zero carbon fuel, such as hydrogen, to minimise carbon dioxide production during combustion.

In the process for producing gaseous fuel, the vitiated air may comprise in the range 0-15 mol % oxygen, often in the range 1-5 mol %. At these levels the gasification reaction to produce gaseous fuel is promoted over heat generation. The lower the level of oxygen present in the vitiated air, the less combustion will occur and the more gaseous fuel will be produced. It may be that the air source is the same for the heat generation process and for the gaseous fuel generation process, with oxygen being removed at, or close to, the point of reaction with the carbonaceous fuel. It is the restriction of oxygen content within the air supply which triggers the alternation between the two processes. Where the air source is the same, vitiation may often be implemented just prior to reaction, although the air may be supplied pre-vitiated. Where the air sources are different, or where the heat generation process uses an alternative source of oxygen, such that the only air source is supplying the process for the generation of gaseous fuel, vitiation may be implemented at any point prior to use, such that the air may be supplied pre-vitiated if appropriate.

Both the heat generation and gaseous fuel generation reactions will produce waste solids in addition to heat and flue gases or gaseous fuel. These will include the calcium carbonate from reaction of lime with carbon dioxide and non-combustible carbonaceous solids, which are generally in the form of ash. As such, the solids produced via either process can comprise a mixture of the ash that would conventionally be generated by the combustion of the carbonaceous fuel and the calcium carbonate. This ash is benign, and can be disposed of in land fill, open land, or on agricultural land as a way of improving soil quality and increasing pH. The calcium carbonate may also be disposed of in these ways, or if generated separately to the ash (or separated therefrom after removal from the reactor), sold as a commodity product. Because the captured carbon dioxide (in the form of calcium carbonate) is in solid form, it does not need to be pressurised and transported by pipeline and subsequently injected into a suitable geological formation for long term sequestration. Thus the costs involved in compressing the carbon dioxide, building pipelines, pumping the carbon dioxide along those pipelines, injecting the carbon dioxide into geological formations and monitoring the geological storage site are obviated by using the grid energy firming process of the invention. This is a particular advantage where the distance over which the compressed carbon dioxide would need to be transported is large.

The grid-energy firming process may be carried out in multiple reactors for the various elements of the heat and subsequent electrical energy generation process, and the gaseous fuel generation process. For instance, the heat generation process could be provided for by a heat generation reactor for the carbonaceous fuel with oxygen, from which carbon dioxide, water (often as steam) and heat are produced, coupled to a second recarbonation reactor containing lime and into which the gaseous mixture flows to provide for the reaction of carbon dioxide with lime and the formation of calcium carbonate. A dual reactor system has the advantage that it is easy to control the temperature of the reactor in which the carbonation reaction occurs, such that the forward reaction (namely oxide to carbonate) is promoted. Similarly, the following steps often found in the process for the generation of gaseous fuels may be carried out in one, two, or three different reactors.

a) gasification of the carbonaceous fuel to produce carbon monoxide and hydrogen;

b) reaction of carbon monoxide with water to produce carbon dioxide and hydrogen; and

c) recarbonation of lime by carbon dioxide to produce calcium carbonate.

However, it will often be the case that either each of the heat generation and generation of gaseous fuel processes occur independently in a single reactor, or that a single reactor is used for both processes. This does not preclude the presence of apparatus for post-processing of the reaction products, for instance the presence of heat exchangers to cool the hot flue gases from the heat generation process, or separation apparatus for the gaseous fuel (for instance where the fuel is syngas and it is desirable to separate the carbon monoxide and hydrogen). As such, reference to a single reactor, be this one each for the heat generation process and the process for the generation of gaseous fuels, or one single reactor in which both the heat generation process and the process for the generation of gaseous fuels occurs, is intended to refer to a reactor in which the carbonaceous fuel is reacted. In addition, it may be that the recarbonation reaction to produce calcium carbonate be carried out in a single reactor into which both process reactors feed where they are otherwise independently constructed.

Where a single reactor is used for both processes, both processes will employ the same carbonaceous fuel, which will generally be a solid as is desirable for the generation of gaseous fuels. However, where different reactors are used, the carbonaceous fuel may be the same or different for the heat generation process and the process for the generation of gaseous fuels.

Often the reactor will be a bed reactor, which may be fixed or continuous (fluidised). For process efficiency, often the reactor will be a fluidised bed reactor, such that switching between heat generation and gaseous fuel generation is achieved by changing the concentration of oxygen in an air supply flowing over the fluidised bed.

It may be the case, that where additional electrical energy is required, the gaseous fuel be combusted to provide heat energy which can be converted to electrical energy as described above. This could be of use where demand for the gaseous fuel is low, or where the cost of the carbonaceous fuel used to prepare the gaseous fuel was particularly low, such that at a later point in time, even where demand for electricity is high (such that the heat generation process is favoured), there are benefits to generating further heat via the use of the stored gaseous fuel, or even directly by the gaseous fuel route. In such examples, it may be that combustion is in the presence of lime, as with the heat generation process, to ensure that if any carbon dioxide is produced by the gaseous fuel, that this is captured.

As such, it may be that the process of generating electrical energy comprises converting the heat generated by the heat generation process into electrical energy and/or comprises combusting the gaseous fuel produced by the process for the generation of gaseous fuel, to generate heat which may be converted into electrical energy.

In a second aspect of the invention there is provided a grid energy firming system for a process of the first aspect of the invention, the system comprising a reactor containing a carbonaceous fuel, and a heat exchanger to extract heat from the flue gas and/or gaseous fuel. The system may alternatively comprise a reactor for the reaction of the carbonaceous fuel with oxygen in the presence of lime in the heat generation process, and a heat exchanger to extract heat from the flue gas; and a second reactor for the gasification of the carbonaceous fuel with vitiated air in the presence of lime and water in the gaseous fuel generation process, and a heat exchanger to extract heat from the gaseous fuel. The heat exchanger may be the same or different. In addition, the system may further comprise one or more of a separator for the gaseous fuel, for instance to separate carbon monoxide and hydrogen in syngas production; a combustion chamber should the gaseous fuel be burnt as part of the overall process; and a turbine for conversion of heat to electricity, among other components.

In a third aspect of the invention there is provided a use of a process according to the first aspect of the invention, or the system according to the second aspect of the invention, in the generation of electrical energy and/or in the generation of gaseous fuels. There is also provided a use of the process for the generation of gaseous fuels in energy distribution, optionally wherein the energy is distributed by transport of the gaseous fuel to the point of use. Alternatively, the energy may be distributed by the combustion of the gaseous fuel to provide heat energy which is converted into electrical energy.

There is further provided the use of a process according to the first aspect of the invention in grid energy firming, optionally wherein heat is converted to electrical energy for release into the grid energy system. Additionally or alternatively the use may comprise the storage and release of gaseous fuel to a grid energy system. This release may be direct release to the grid energy system, or combustion of the gaseous fuel to provide heat which is converted into electrical energy for release to the grid energy system. It will typically be the case that electrical energy is supplied to the grid when demand exceeds supply, and a gaseous fuel is produced and stored when supply exceeds demand.

Unless otherwise stated, each of the integers described may be used in combination with any other integer as would be understood by the person skilled in the art. Further, although all aspects of the invention preferably “comprise” the features described in relation to that aspect, it is specifically envisaged that they may “consist” or “consist essentially” of those features outlined in the claims. In addition, all terms, unless specifically defined herein, are intended to be given their commonly understood meaning in the art.

Further, in the discussion of the invention, unless stated to the contrary, the disclosure of alternative values for the upper or lower limit of the permitted range of a parameter, is to be construed as an implied statement that each intermediate value of said parameter, lying between the smaller and greater of the alternatives, is itself also disclosed as a possible value for the parameter.

In addition, unless otherwise stated, all numerical values appearing in this application are to be understood as being modified by the term “about”.

In order that the invention may be more readily understood, it will be described further with reference to the figures hereinafter.

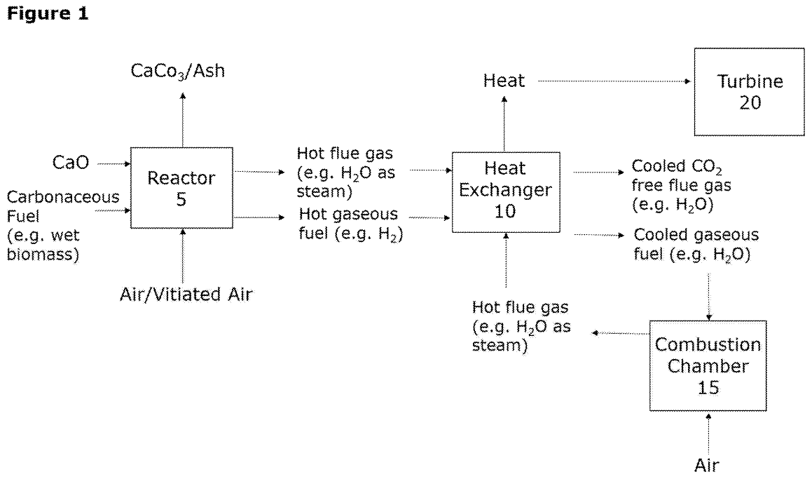

FIG. 1 is a schematic representation of a process and system of the invention comprising a single reactor for both the heat generation and the generation of gaseous fuel, together with subsequent combustion of the gaseous fuel to generate more heat;

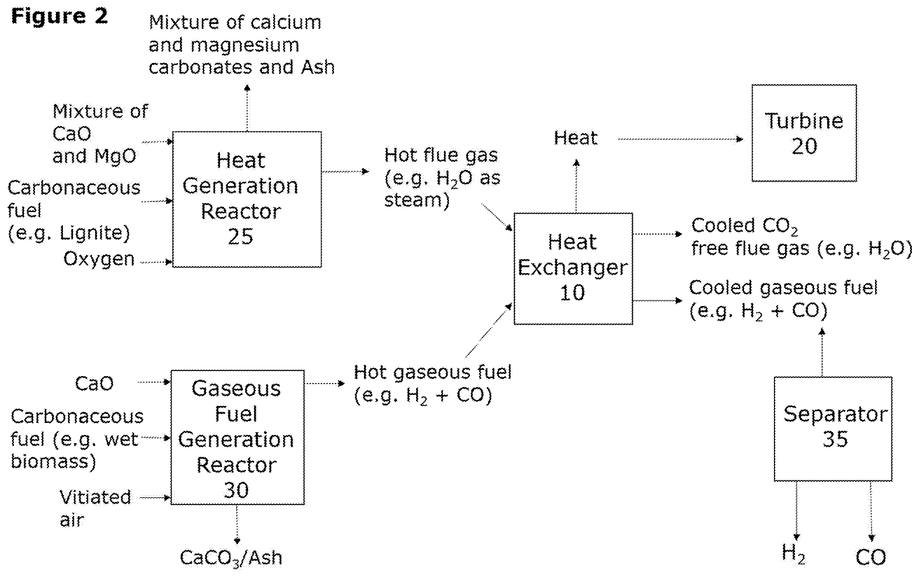

FIG. 2 is a schematic representation of a process and system of the invention comprising a single reactor for each of the heat generation and the gaseous fuel processes, together with a subsequent separation step for the gaseous fuels; and

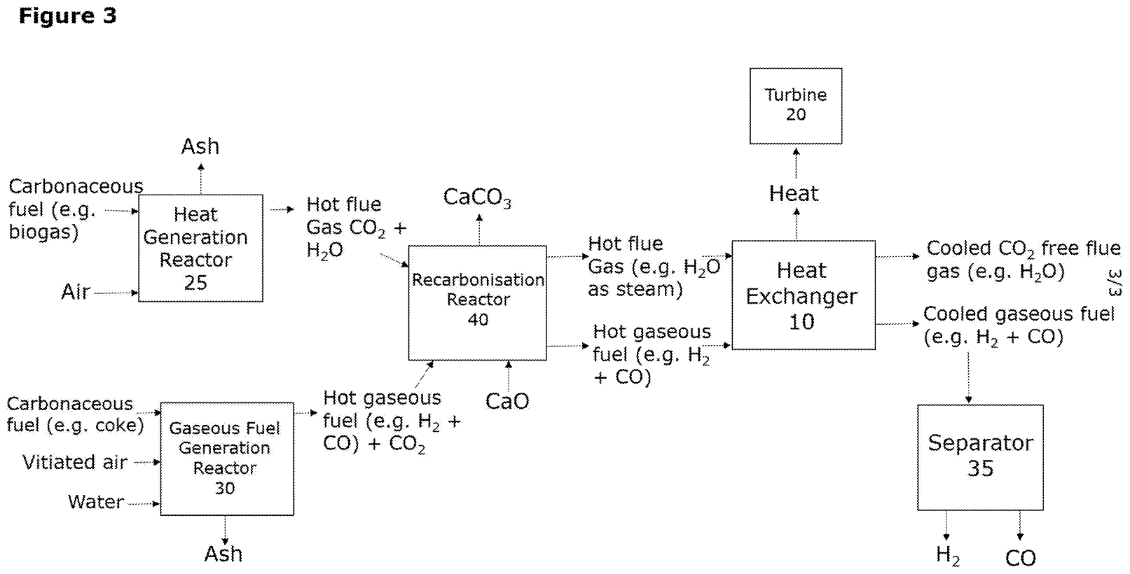

FIG. 3 is a schematic representation of a process and system of the invention comprising multiple reactors, together with a subsequent separation step for the gaseous fuels.

FIG. 1 shows one implementation of the process and system of the invention. The system comprises fluidised bed reactor 5 comprising the carbonaceous fuel (for instance wet biomass) and lime. The reactor 5 is held at a temperature of approximately 750° C. To this is added air of controlled oxygen content, either vitiated if the reactor is in gaseous fuel generation mode, or non-vitiated if heat is to be generated. The solid reaction products, primarily ash and calcium carbonate, are removed from the reactor and distributed on land to improve soil quality. The hot gaseous products pass from the reactor to a heat exchanger 10 where they are cooled. The gaseous products in this example will be hot flue gas containing, for instance, water as steam together with nitrogen and any unreacted oxygen, if operating in heat generation mode; or hot gaseous fuel, such as hydrogen, if operating in gaseous fuel generation mode. The cooled flue gas, now water and oxygen depleted air, will be released to the environment. In this example, at least some of the cooled gaseous fuel, hydrogen, is combusted in chamber 15, and the hot flue gas (water as steam) passed through heat exchanger 10. The heat in this process is converted to electricity in turbine 20.

FIG. 2 shows an alternative implementation of the process and system of the invention. The system of FIG. 2 comprises a fixed bed heat generation reactor 25 and a fixed bed gaseous fuel generation reactor 30, together with a single heat exchanger 10, passing heat into turbine 20, and a gas separator 35. In this implementation, heat generation reactor 25 comprises carbonaceous fuel (in this case lignite) and a combination of lime and magnesium oxide. When electricity is required for the grid energy system, pure oxygen is introduced to reactor 25 to combust the lignite, the carbon dioxide produced recarbonates the lime and magnesium oxide in situ to form calcium/magnesium carbonate. The solid reaction products, primarily ash and calcium/magnesium carbonate are removed from reactor 25 and distributed on land to improve soil quality. The hot flue gases, including water as steam, pass to heat exchanger 10 where they are cooled. The cooled flue gas, including liquid water, is then released to the environment and the heat is used to drive turbine 20 thereby generating electricity. When electricity demand in the grid energy system is low, the gaseous fuel generation process is operated, using gaseous fuel generation reactor 30. A carbonaceous fuel, in this example wet biomass, is added to the reactor 30, together with lime and vitiated air. The solid reaction products, namely ash and calcium carbonate are removed from reactor 30 and distributed on land. The hot gaseous fuel (in this example syngas formed of carbon monoxide and hydrogen as carbon dioxide has been sequestered during the formation of calcium carbonate) is passed to heat exchanger 10, where they are cooled. In this example, the cooled syngas is then separated in gas separator 35, to provide pure carbon monoxide and hydrogen.

FIG. 3 shows a further implementation of the process and system of the invention. The system of FIG. 3 is similar to the system of FIG. 2, and comprises a heat generation reactor 25, for instance a Combined Heat and Power (CHP) reactor, and (in this case) a fluidised bed gaseous fuel generation reactor 30, together with a single heat exchanger 10, passing heat into turbine 20, and a gas separator 35. However, in this implementation, the heat generation reactor 25 and gaseous fuel generation reactor 30 do not facilitate recarbonation. Recarbonation occurs in fluidised bed recarbonation reactor 40. As such, the hot flue gas released from heat generation reactor 25 in this example includes carbon dioxide, as does the gaseous fuel released from reactor 30. By way of specific illustration, heat generation reactor 25 comprises carbonaceous fuel, such as biogas which is burned in air. The hot flue gases comprise carbon dioxide and water and are transferred to recarbonation reactor 40, where they are passed over lime, which absorbs the carbon dioxide and forms calcium carbonate. When the gaseous fuel generation process is operating in reactor 30, the carbonaceous fuel, for instance coke, is reacted with vitiated air and water (often as moisture carried in the air). The gaseous fuel released from this reactor 30 comprises, for instance, syngas (hydrogen, carbon monoxide—and carbon dioxide). The fuel is transferred to recarbonation reactor 40, where it is passed over lime which absorbs the carbon dioxide. After recarbonation in reactor 40, all gases are passed to heat exchanger 10, and processed as described above for FIG. 2. In this example, the separate production of ash from reactors 25 and 30, and calcium carbonate from reactor 40 provides for the use of calcium carbonate as a commodity product without further purification if desired, whilst the ash may be spread on the land as before.

It would be appreciated that the process and system of the invention are capable of being implemented in a variety of ways, only a few of which have been illustrated and described above.

1. A grid-energy firming process, the process comprising alternating between a process for generating electrical energy, and a process for generating gaseous fuels in response to the energy demands of a grid energy system, wherein the process comprises combusting a carbonaceous fuel in the presence of a metal oxide,
wherein the ratio of oxygen carbonaceous fuel in the combustion reaction is controlled such that when the ratio of oxygen; carbonaceous fuel is increased, the combustion reaction produces CO₂, H₂O and heat, and when the ratio of oxygen, carbonaceous fuel is decreased, the combustion reaction produces syngas and CO₂.

2. A process according to claim 1, wherein the process for generating electrical energy comprises a process for heat generation, wherein the heat generated is converted to electrical energy.

3. A process according to claim 2, wherein the process for heat generation, comprises reacting a carbonaceous fuel with oxygen in the presence of a metal oxide to provide a metal carbonate, water and heat.

4. A process according to claim 3, wherein the metal oxide is selected from calcium oxide and/or magnesium oxide, and the metal carbonate is calcium carbonate and/or magnesium carbonate.

5. A process according to claim 2, wherein the oxygen is oxygen from air.

6. A process according to claim 2, wherein the water and heat are released as a flue gas.

7. A process according to claim 2, comprising the overall reaction:
CₐH_{b}O_{c}+aCaO+x(a+b/2−c)O₂+3.29x(a+b/2−c)N₂→3.29x(a+b/2−c)N₂+(1−x)(a+b/2−c)O₂+bH₂O+aCaCO₃
where a, b and c are the molar component of the carbonaceous fuel, and x is the excess air fraction.

8. A process according to claim 1, wherein the process for generating gaseous fuels comprises gasifying a carbonaceous fuel with vitiated air in the presence of metal oxide and water to provide a metal carbonate, a gaseous fuel and heat.

9. A process according to claim 8, comprising:
a) gasification of the carbonaceous fuel to produce carbon monoxide and hydrogen:
b) reaction of carbon monoxide with water to produce carbon dioxide and hydrogen, and
c) recarbonation of the metal oxide by carbon dioxide to produce metal carbonate.

10. A process according to claim 8, wherein the metal oxide is selected from calcium oxide and/or magnesium oxide, and the metal carbonate is calcium carbonate and/or magnesium carbonate.

11. A process according to claim 8, wherein the gaseous fuel is combusted to provide heat energy.

12. A process according to claim 8, wherein the gaseous fuel is selected from syngas, or hydrogen.

13. A process according claim 8, wherein the gaseous fuel is a low or zero carbon fuel.

14. A process according to claim 8, comprising the overall reaction:
CₐH_{b}O_{c}+aCaO+N₂+H₂O→N₂+CₓH_{y}+(a−x)CaCO₃
where a, b and c are the molar component of the carbonaceous fuel, and x may vary from 0 to 8 and y may vary from 2 to 14.

15. A process according to claim 2, wherein the heal generation process and the process for generating gaseous fuels occurs in a single reactor.

16. A process according to claim 15, wherein the reactor is a bed reactor.

17. A process according to claim 3, wherein the carbonaceous fuel comprises a solid fuel.

18. A process according to claim 17, wherein the carbonaceous fuel is selected from coal, coke, lignite, biomass, one or more hydrocarbons, or a combination thereof.

19. A grid energy firming system, for a process of claim 1, the system comprising a reactor containing a carbonaceous fuel, and a heat exchanger to extract heat from the flue gas and/or gaseous fuel.

20. A use of a process or system according to claim 1, in grid energy firming.

21. A use according to claim 20, wherein heat is converted to electrical energy for release into a grid energy system.

22. A use according to claim 20, comprising the storage and release of gaseous fuel to a grid energy system.

23. A use according to claim 22, wherein the gaseous fuel is directly released to the grid energy system.

24. A use according to claim 22, wherein the gaseous fuel is combusted to provide heat which is converted into electrical energy for release to the grid energy system.

25. A use according to claim 20, wherein electrical energy is supplied to the grid when demand exceeds supply, and a gaseous fuel is produced and stored when supply exceeds demand.
